(19) United States
(12) Patent Application Publication
(10) Pub. No.: US 2023/0152663 A1
(43) Pub. Date: May 18, 2023

(54) DEVICE FOR SPECTRAL BROADENING OF A LASER PULSE AND LASER SYSTEM

(71) Applicant: Helmut-Schmidt-Universität / Universität der Bundeswehr Hamburg, Hamburg (DE)

(72) Inventors: Oleg Pronin, Hamburg (DE); Kilian Fritsch, Hamburg (DE); Victor Hariton, Hamburg (DE)

(21) Appl. No.: 18/056,969

(22) Filed: Nov. 18, 2022

Related U.S. Application Data
(63) Continuation of application No. PCT/EP2021/062702, filed on May 12, 2021.

(30) Foreign Application Priority Data
May 20, 2020 (DE) 10 2020 113 631.5

(51) Int. Cl. G02F 1/35; G02B 17/00; G02B 17/06

(52) U.S. Cl. CPC G02F 1/3503; G02B 17/004; G02B 17/061; G02F 1/3542

(57) ABSTRACT

A device for spectrally broadening a laser pulse is disclosed. The device includes a multipass arrangement having a convex mirror and a concave mirror, the convex mirror and the concave mirror being arranged relative to each other such that a laser pulse coupled into the multipass arrangement is reflected at least once from the concave mirror to the convex mirror and at least once from the convex mirror to the concave mirror. Further, the device includes a nonlinear optical medium arranged at least partially within the multipass arrangement such that the laser pulse coupled into the multipass arrangement passes through the nonlinear optical medium multiple times. The disclosure also relates to a laser system having a device according to the disclosure for spectral broadening of a laser pulse.

### CROSS REFERENCE TO RELATED APPLICATIONS

This application is a continuation application of international patent application PCT/EP2021/062702, filed May 12, 2021, designating the U.S. and claiming priority to German patent application DE 10 2020 113 631.5, filed May 20, 2020, both of which are hereby incorporated by reference in their entireties.

### TECHNICAL FIELD

The present disclosure relates to a device for spectral broadening of a laser pulse, a laser system and a use of a multipass arrangement for spectral broadening of a laser pulse. Thus, the disclosure relates particularly to the field of laser technology.

### BACKGROUND

Multipass arrangements are devices in which a laser beam or pulse is propagated a predetermined number of times and then coupled out. Multipass arrangements are often used in the application of non-linear optical processes, such as in the application of non-linear optical spectral broadening of laser pulses, in which a non-linear optical medium in solid form and/or in gas form is arranged in the multipass arrangement and during the propagation of the laser pulse or laser beam in the multipass arrangement the laser beam passes through it several times. In multipass arrangements, the laser beam propagates unguided through free space, i.e., there is no guided propagation of the beam, as is the case in optical fibers, for example. Multipass arrangements can also be used for other nonlinear optical processes, such as self-frequency shifting and self-compression.

Nonlinear pulse compression by means of spectral broadening using self-phase modulation (SPM) and a subsequent temporal compression of the laser pulses, for example by means of dispersive mirrors or by means of grating compressors, is a well-known technology and is often applied in femtosecond laser systems. The Kerr nonlinearity of solid-state nonlinear optical media is often exploited, which denotes an intensity dependence of the refractive index of the nonlinear optical medium. The refractive index n can be mathematically expressed as follows:

n=n₀+n₂I.

Here, no denotes the intensity-independent refractive index, n₂ the nonlinear refractive index, and I the intensity of the laser pulse. The Kerr nonlinearity, which occurs when a laser pulse with high peak intensity propagates through the nonlinear medium, causes a rapid modulation of the temporal phase Φ(t) which can be expressed as follows:

Φ(t)=kₙΔnL=kₙn₂I(t)L

Here, kₙ indicates the wavenumber and L the propagation length of the laser pulse in the nonlinear medium. This temporal phase can also be called longitudinal temporal phase to express its dependence on the propagation length L. The rapid modulation of the temporal phase leads to the emergence of new spectral components in the frequency spectrum of the laser pulse, since the frequency is the time derivative of the temporal phase. This is represented by ω=∂/∂(t)Φ(t) mathematically, where O denotes the angular frequency. In general, the intensity of a laser pulse depends on the radial position in the beam (denoted as r), leading to a radial or spatial dependence of the optical path length OPL(t,r) (n₀+n₂ I(t,r))d. In most solid-state nonlinear media, this, together with a usual intensity profile of the laser pulse according to a Gaussian radial intensity distribution, leads to self-focusing of the laser beam at sufficiently high intensities, which may be accompanied by a degradation of the laser beam profile. Due to the temporal and spatial dependence of the intensity of the laser pulse, the spectral distribution of the frequencies of the laser pulse after SPM may also exhibit an undesirable radial spatial dependence. However, it was experimentally demonstrated in 1994 that by means of multipass propagation of the laser pulse in a regenerative amplifier cavity, the undesired self-focusing or radial spatial accumulation of the SPM, can be suppressed while the desired longitudinal phase of the SPM can be increased (Li Yan, Yuan-Qun Liu, and C. H. Lee, “Pulse temporal and spatial chirping by a bulk Kerr medium in a regenerative amplifier,” IEEE J. Quantum Electron. vol. 30, no. 9, pp. 2194-2202, 1994). Pulse compression using unguided propagation of the laser pulse is typically performed in multipass arrangements formed as Herriott Cells (HC), where a nonlinear optical medium is placed in the HC.

The strength of nonlinear effects and/or accumulated phase shifts are typically characterized or specified in terms of their strength by the so-called B-integral. The B-integral is typically specified only for the position of the laser pulse on the optical axis, i.e., in the center of the pulse at r=0, and is mathematically expressed as follows:

$$B = \frac{2 π}{λ} \int {n}_{2} I ( z ) dz$$

Here k indexes the central wavelength of the laser pulse. The B integral is essentially proportional to the intensity of the laser pulse and the propagation distance in the nonlinear medium. For a desired strong spectral broadening and a high degree of pulse compression, a high B-integral is desirable.

However, strongly pronounced nonlinear effects also bring other undesirable side effects, which cannot always be avoided and can lead to various problems. For example, the presence of high peak intensities in the laser pulse or of highs during propagation through the nonlinear medium can reach or exceed the threshold of critical self-focusing, at which self-focusing occurs due to Kerr nonlinearity and focuses the laser pulse in the nonlinear medium in such a way that the nonlinear medium is damaged and destroyed. This can occur, for example, by destruction of a solid-state nonlinear medium and/or by ionization of a gaseous nonlinear medium. For example, the ionization threshold for argon is about 10¹⁴ W/cm². Other gases also have similar ionization thresholds. If the intensity of the laser pulse in such a nonlinear medium exceeds this ionization threshold, the nonlinear medium will be ionized, at least partially dissipating the laser pulse and dramatically degrading the beam profile of the laser pulse. Destruction of a solid-state nonlinear medium can be in the form of, for example, turbidity or even mechanical destruction of the nonlinear medium. Therefore, spectral broadening due to continuous propagation of the laser beam through the nonlinear optical medium is not accessible for such peak powers of laser pulses where the destruction threshold is reached or the destruction threshold would be expected due to critical self-focusing.

In order to at least partially circumvent or reduce the limitations due to critical self-focusing in the spectral broadening of laser pulses, an approach is known in the related art in which spectral broadening is achieved by multiple propagations of the laser pulse through a nonlinear optical medium that is kept short (see DE 10 2014 007 159 A1). In this case, the nonlinear medium is kept short in such a way that the laser pulse leaves it again before significant self-focusing and, in particular, critical self-focusing occurs. In order to nevertheless obtain a B integral sufficient for spectral broadening, the laser pulse is propagated through the nonlinear optical medium several times, i.e., in several passes. Since after each pass of the laser pulse through the nonlinear optical medium a refocusing of the laser pulse by a concave mirror takes place, the effect of self-focusing can be at least partially reduced or eliminated.

However, another limitation of using nonlinear effects in general and nonlinear spectral broadening and pulse compression in particular is the damage threshold of the optical elements used. Typically, two opposing concave mirrors are used in HC, through which a multipass arrangement is created by means of multiple reflections of the laser pulses between the mirrors. The laser pulse or laser beam is focused by the concave mirrors, so that very high intensities can occur in the areas with smaller beam diameter and especially in the focus, which can significantly exceed the damage threshold of the optics used. For this reason, in such multipass arrangements using two concave mirrors, it must always be ensured that the beam diameter is sufficiently large and the intensity sufficiently small at the points where the laser pulse hits the optical elements, in order to prevent the destruction threshold from being exceeded and the optical elements from being destroyed as a result. Therefore, in order to spectrally broaden pulses with high pulse energy with such an arrangement, a corresponding upscaling is required, i.e., the optical path lengths and the diameters of the optical elements used must be selected to be so large that sufficiently large beam diameters can be used to avoid reaching and exceeding the destruction threshold. For example, in the prior art, an HC with two concave mirrors is known to have a considerable length of 8 m for compressing laser pulses with a pulse energy of 40 mJ (published in M. Kaumanns et al., Eds, Multipass spectral broadening with tens of millijoule pulse energy: Optical Society of America, 2019). Complicating matters further, the damage threshold of dielectric mirrors, which are the typical dispersive optical elements for dispersion control, is in some cases a factor of 2 to 3 lower than the damage threshold of metallic, highly reflective mirrors. Therefore, when such dielectric mirrors are intended to be used, the maximum pulse energy should be even smaller and/or the diameters of the optics and the optical path lengths should be even larger. Also, a folding of the multipass arrangement, where e.g., concave mirrors are used together with a plane mirror, brings the disadvantage that significantly higher intensities are to be expected at the plane mirror due to a smaller beam diameter and therefore the limitation for the pulse energy or peak intensity would prohibit the use with high-intensity laser pulses.

### SUMMARY

It is therefore an object of the present disclosure to provide a device for spectral broadening of a laser pulse, which is suitable for laser pulses with high peak intensity.

This task is solved according to the disclosure by a device, a laser system and a use as disclosed herein. Exemplary embodiments are discussed below.

In a first aspect, the disclosure relates to a device for spectrally broadening a laser pulse. The device comprises a multipass arrangement having a convex mirror and a concave mirror, the convex mirror and the concave mirror being arranged relative to each other such that a laser pulse coupled into the multipass arrangement is reflected at least once from the concave mirror to the convex mirror and at least once from the convex mirror to the concave mirror. Furthermore, the device comprises a nonlinear optical medium which is arranged at least partially within the multipass arrangement in such a way that the nonlinear optical medium is passed through several times by the laser pulse coupled into the multipass arrangement.

In another aspect, the disclosure relates to a laser system comprising a device according to the disclosure for spectrally broadening a laser pulse.

In another aspect, the disclosure relates to a use of a multipass arrangement comprising a convex mirror and a concave mirror for spectral broadening of a laser pulse, wherein the convex mirror and the concave mirror are arranged with respect to each other in such a way that a laser pulse coupled into the multipass arrangement is reflected at least once from the concave mirror to the convex mirror and at least once from the convex mirror to the concave mirror and the laser pulse propagates for spectral broadening through a nonlinear optical medium arranged in the multipass arrangement.

The terms laser beam and laser pulse are used as synonyms, since pulsed laser radiation is also to be described in terms of the optical path in the form of a laser beam. The terms laser pulse and laser pulse are also used as synonyms.

A multipass arrangement is an arrangement of optical elements which deflects a laser pulse or laser beam coupled into the multipass arrangement in such a way that it propagates several times in the multipass arrangement before the laser pulse or laser beam is coupled out of the multipass arrangement again. The deflection of the laser beam optionally takes place by reflections of the laser beam or laser pulse, so that the laser beam or laser pulse changes its propagation direction in the multipass arrangement. In contrast to arrangements which guide the beam by means of optical fibers through total internal reflection, in the multipass arrangement propagation of the laser beam takes place in free space without the beam mode being restricted by an optical fiber at any point along the optical path of the laser beam or laser pulse.

A concave mirror is a curved mirror whose reflecting surface is curved inwards, i.e., the center of the concave mirror is set further back than the edges of the mirror. The concave mirror may optionally have a spherical or aspherical curvature. For example, an aspherical curvature may be formed as a parabolic curvature, although other curvature forms are also possible. In this case, the concave mirror is formed such that a collimated laser beam incident on the concave mirror is focused by the concave mirror. In this description, the radius of curvature of a concave mirror is typically given as a negative value, although the sign of the curvature value does not indicate the direction of the curvature. A concave mirror is also a concave mirror if its radius of curvature is specified with a positive or no sign.

A convex mirror is a curved mirror whose reflecting surface is curved outward, i.e., the edges of the concave mirror are set further back than the center of the mirror. The convex mirror may optionally have a spherical or aspherical curvature. For example, an aspherical curvature may be formed as a parabolic curvature, although other curvature forms are also possible. The convex mirror is designed in such a way that a collimated laser beam incident on the concave mirror is expanded or widened by the convex mirror. In this description, the radius of curvature of a convex mirror is typically given as a positive value, although the sign or lack of sign of the curvature value does not indicate the direction of curvature. A convex mirror is also a convex mirror if its radius of curvature is specified with a negative sign.

In this context, the fact that the nonlinear optical medium, which in the present disclosure is referred to by the synonymous term “nonlinear medium,” is arranged at least partially within the multipass arrangement means that at least part of the nonlinear medium is arranged within the multipass arrangement. Optionally, the nonlinear medium is arranged completely within the multipass arrangement. However, in particular when a gaseous nonlinear medium is used, a part of the gaseous nonlinear medium may also be arranged outside the multipass arrangement. However, for spectral broadening of a laser pulse, it is necessary that the laser pulse passes or propagates through the nonlinear medium. The nonlinear medium must therefore be arranged in the multipass arrangement in such a way that such propagation of the laser pulse in the nonlinear medium is at least partially enabled during the revolutions in the multipass arrangement.

The fact that the laser pulse passes through the multipass arrangement several times means that the laser pulse propagates several times or several circulations in the multipass arrangement. One circulation can optionally be realized by reflecting the laser pulse twice in the multipass arrangement, so that the laser pulse changes its propagation direction twice and propagates after two reflections in approximately the same direction as before the two reflections.

Coupling a laser pulse into the multipass arrangement means that a laser pulse or laser beam coming from outside the multipass arrangement is guided into the multipass arrangement and is then deflected several times by the multipass arrangement in order to propagate several circulations in the multipass arrangement. Decoupling of the laser pulse from the multipass arrangement means that the laser pulse leaves the multipass arrangement again after propagating several circulations through the multipass arrangement.

The disclosure offers the advantage of providing a device for spectral broadening of laser pulses in which no focusing of the laser beam is necessarily required. Because the multipass arrangement essentially has one convex and one concave mirror, it is not necessary to focus the laser beam between the two mirrors, as is the case in particular with conventional Herriott cells with two concave mirrors. As a result, small beam diameters and correspondingly high intensities can be avoided in the device or in the multipass arrangement. This in turn offers the advantage that disadvantageous effects typically associated with small beam diameters can be avoided, such as damage to optical elements by exceeding the (laser-induced) damage threshold (LIDT) and/or the unwanted occurrence of self-focusing, for example in a gaseous nonlinear optical medium, and/or the unwanted occurrence of ionization of a gas medium in the multipass arrangement, such as air and/or a gaseous nonlinear optical medium.

The disclosure also offers the advantage that the device and in particular the multipass arrangement can be constructed in a particularly compact manner, i.e., the spatial dimensions of the device or multipass arrangement can be selected to be particularly small, in contrast to conventional Herriott cells which are based on two concave mirrors. By the fact that in a device and multipass arrangement according to the disclosure a focusing of the laser beam is not necessarily required, it is also not necessary to consider the beam diameter size when choosing the distance between the two mirrors of the multipass arrangement in order to avoid destruction or damage of the mirrors. By not necessarily focusing in the multipass arrangement according to the disclosure, the beam diameter at any point along the optical path in the multipass arrangement can be chosen to be so large that the expected intensity of an injected laser beam or laser pulse is (significantly) below the damage threshold of the optical elements, in particular of the convex and concave mirror. Thus, the disclosure offers the advantage that different laser systems can be equipped with a compact device for spectral broadening of a laser pulse.

The disclosure also offers the advantage that a multipass arrangement according to the disclosure can optionally be folded, i.e., the beam path of the laser beam in the multipass arrangement can be deflected by one or more deflection mirrors and in this way the spatial dimensions can be reduced even further. This represents a further advantage over conventional Herriott cells based on two concave mirrors, since in these the insertion of a deflection mirror between the two concave mirrors would inevitably mean that the deflection mirror would have to be arranged in an area with smaller beam diameters (compared to the concave mirrors) and accordingly either the maximum pulse energy or peak intensity of laser pulses would have to be reduced, or the intensity of the laser pulses at the location of the deflection mirror would exceed its damage threshold.

The disclosure also offers the advantage that the optical path length of the laser pulses in the multipass arrangement can be kept low compared to conventional Herriott cells due to the possibility of compact construction of the multipass arrangement. This is particularly advantageous in that the time delay which the laser pulses accumulate during propagation through the multipass arrangement can be kept low and in this way an optionally required compensation of this time delay to a split-off laser pulse, for example for pump-probe applications, can be facilitated.

Furthermore, the disclosure offers the advantage that the volume of a multipass arrangement and device according to the disclosure can be kept low. In particular, this may offer advantages in that it may simplify or enable the provision of a high pressure atmosphere in the multipass arrangement. Accordingly, this may enable or simplify the use of a gaseous nonlinear medium. The smaller spatial dimensions enabled by a multipass arrangement according to the disclosure can greatly simplify the provision of a sealed volume that can withstand high pressure differences.

In addition, the disclosure provides the surprising effect that when using a multipass arrangement with a concave mirror and a convex mirror for spectral broadening of laser pulses, a beam quality sufficient and suitable for further use of the laser pulses can also be maintained, as shown in the following explanation of exemplary embodiments and examples. In particular, the beam quality can be judged to be equivalent to the beam quality when using a conventional HC. This contradicts the so far prevailing opinion in the related art that multipass arrangements with one concave and one convex mirror would have a negative impact on the spectral homogeneity of the laser pulses and on the beam profile and are therefore not suitable for use as multipass arrangements for spectral broadening of laser pulses (see M. Hanna et al, “Nonlinear temporal compression in multipass cells: theory,” J. Opt. Soc. Am. B, vol. 34, no. 7, p. 1340, 2017). However, contrary to this well-established view in the field, the inventors were able to show that a beneficial use of a multipass arrangement with one concave and one convex mirror for spectral broadening of laser pulses is possible and advantageous.

The nonlinear optical medium is optionally passive. This means that the nonlinear optical medium is not designed to actively amplify a passing laser pulse. Accordingly, the nonlinear optical medium is designed not to be pumped and/or not to exhibit laser activity. Optionally, the nonlinear optical element is adapted to induce one or more nonlinear optical effects upon passage of a laser pulse solely due to the nonlinear refractive index, which effects result in or are capable of spectral broadening of the laser pulse. In particular, the nonlinear optical medium may differ from an active laser medium in that the nonlinear optical medium does not include an active element suitable and/or configured to cause population inversion for laser activity.

Optionally, the entire device is passive. In other words, the device has no active element and/or active laser medium. In other words, the device is designed in such a way that the nonlinear optical element is passive and the device also has no other active element or active laser medium.

Optionally, the multipass arrangement is designed such that the laser pulse coupled into the multipass arrangement is reflected several times, optionally more than ten times, from the concave mirror to the convex mirror and several times, optionally more than ten times, from the convex mirror to the concave mirror. This offers the advantage that a multiple passage of the coupled laser pulse through the nonlinear optical medium arranged in the multipass arrangement can be achieved.

Optionally, the multipass arrangement is designed such that the laser pulse coupled into the multipass arrangement is reflected from the concave mirror directly to the convex mirror and from the convex mirror directly to the concave mirror. In other words, optionally no further deflection mirror is arranged between the concave mirror and the convex mirror in the multipass arrangement. This offers the advantage that a particularly simple structure of the multipass arrangement is made possible and possible negative effects on the beam profile can be avoided.

Optionally, the multipass arrangement also has one or more deflection mirrors. This offers the advantage that beam folding can be achieved in the multipass arrangement and thus the multipass arrangement can be constructed in a particularly compact manner.

Optionally, the nonlinear optical medium comprises a solid medium. This offers the advantage that the nonlinear optical medium can be arranged at a defined position in the multipass arrangement and, in addition, a defined propagation length of the laser pulse can be determined by the nonlinear optical medium. This also offers the advantage that the solid-state nonlinear optical medium can have a strongly pronounced nonlinear refractive index. In addition, a solid-state nonlinear medium is usually subject to no or only very small dependencies on ambient pressure and only very small changes with temperature fluctuations. Optionally, the solid-state nonlinear optical medium is at least partially formed of sapphire and/or SiC and/or diamond and/or fused silica. These exhibit a strongly pronounced nonlinear refractive index and a comparatively high damage threshold. Alternatively or additionally, a nonlinear medium may comprise or consist of ZnS and/or ZnSe, which is advantageous for mid-infrared wavelengths. Alternatively or additionally, the nonlinear optical medium may comprise YAG and/or noble gases and/or Raman-active gases, such as H₂, N₂, O₂, and/or CO₂, and/or fluoride glasses, such as MgF₂ and/or CaF₂. Optionally, other materials not explicitly mentioned can be used for the nonlinear medium, which have a pronounced nonlinear refractive index and optionally a high damage threshold.

Optionally, the nonlinear medium has a gaseous medium or is designed as such. This allows particularly long propagation lengths of the laser pulse through the nonlinear optical medium, since optionally the multipass arrangement can be completely filled with the gaseous nonlinear medium. Further, a nonlinear optical medium offers degrees of freedom with respect to the prevailing nonlinearity due to the adjustability of the gas pressure. Further, a gaseous nonlinear medium offers the advantage that the ionization threshold is typically higher than the damage threshold of solid-state nonlinear optical media and, consequently, can withstand laser pulses of higher intensity than solid-state nonlinear media. Optionally, the device is arranged in a pressure chamber and/or formed as a pressure chamber, wherein the gaseous medium is provided in the pressure chamber. This simplifies the provision of the gaseous nonlinear medium in the multipass arrangement.

Optionally, the device and/or the multipass arrangement comprises at least one dispersive optical element designed to at least partially compensate and/or overcompensate for spectral dispersion caused in the nonlinear optical medium. For the compression of laser pulses, in addition to spectral broadening, dispersion control is typically crucial to obtain a short laser pulse, ideally close to the Fourier limit. Therefore, it is advantageous if dispersion control is at least partially already performed in the multipass arrangement, which can be achieved by appropriate dispersive optical elements in the multipass arrangement. Furthermore, an at least partial dispersion control within the multipass arrangement offers the advantage that the laser pulse changes its temporal intensity course only slightly, whereby a high efficiency and effectiveness of the broadening can be achieved.

Typically, the dispersive optical element is designed as a dispersive coating of the concave mirror and/or the convex mirror, which is designed to at least partially compensate or overcompensate for spectral dispersion caused in the nonlinear optical medium. This offers the advantage that no further optical elements need to be provided and, accordingly, the design of the device and/or the laser system can be simplified and/or further power losses due to additional reflections at any additional dispersive optical elements can be avoided. In particular, the dispersive optical elements and/or coatings can be designed to at least partially compensate for the second order dispersion (group delay dispersion, GDD) and/or the third order dispersion (TOD) which act on the laser pulse due to propagation through the nonlinear medium.

Optionally, the concave mirror and/or the convex mirror have a recess for coupling the laser pulse into the multipass arrangement and/or for coupling the laser pulse out of the multipass arrangement. This enables easy coupling and decoupling of laser pulses into and out of the multipass arrangement.

Optionally, the multipass arrangement comprises a Herriott cell or is designed as such. This offers the advantage that the advantages of a Herriott cell and the advantages of the multipass arrangement based on a convex and a concave mirror can be combined.

Optionally, when using a solid-state nonlinear optical medium, the nonlinear phase collected by a laser pulse per circulation in the multipass arrangement may be in a range of about 0.2 rad to 2 rad, optionally in a range of about 0.2 rad to 0.6 rad. When using a gaseous nonlinear medium, the nonlinear phase collected per revolution can optionally be in a range from about 0.2 rad to 6.0 rad, optionally from about 0.2 rad to 3.0 rad. In the selection of the nonlinear phase to be collected, the desired spectral broadening, which requires a pronounced nonlinear phase, and, on the other hand, the resulting beam quality of the spectrally broadened laser pulse, for which too great a degree of nonlinear phase can be disadvantageous, can optionally be taken into account, provided that the intended application of the laser pulses places certain requirements on the beam profile.

The number of revolutions of a laser pulse in the multipass arrangement is optionally in a range from 2 to 100, optionally in a range from 10 to 29. The upper limit of the number of revolutions may result, for example, from the spatial size of the multipass arrangement required for this purpose and the manufacturing costs, since a larger number of revolutions typically also requires the use of larger mirrors.

The features and exemplary embodiments mentioned above and explained below are not only to be regarded as disclosed in the combinations explicitly mentioned in each case, but are also encompassed by the disclosure content in other technically useful combinations and exemplary embodiments.

Further details and advantages of the disclosure will now be explained in more detail with reference to the following exemplary embodiments with reference to the figures.

### BRIEF DESCRIPTION OF THE DRAWINGS

The disclosure will now be described with reference to the drawings wherein:

FIG. 1 shows a schematic representation of a conventional device for spectral broadening of a laser pulse with a conventional related art multipass arrangement 20;

FIG. 2 shows a schematic representation of a device for spectral broadening of a laser pulse according to an exemplary embodiment of the disclosure;

FIG. 3 shows a schematic representation of a multipass arrangement according to another exemplary embodiment;

FIG. 4A shows a schematic explanation for the stability criteria of a concave-convex multipass arrangement;

FIGS. 4B to 4E show exemplary courses of reflection point curves on a mirror surface for different values of parameters;

FIG. 5 shows in a diagram the course of the beam radius along the propagation length through the Herriott cell or multipass arrangement;

FIG. 6 shows in a graph the beam radius and the cumulative B-integral versus the propagation length through the multipass arrangement;

FIG. 7 shows the temporal power curve of the simulated laser pulse after spectral broadening and compression and the simulated spectrum after spectral broadening and compression;

FIG. 8 shows the measured spectrum and the output spectrum determined by means of a FROG measurement after spectral broadening with the concave-convex device according to the exemplary embodiment;

FIG. 9 shows the measured spectrum and the output spectrum determined by means of a FROG measurement after spectral broadening with a conventional concave-concave Herriott cell;

FIG. 10 shows the calculated spectral overlap for both axes after broadening with the concave-convex device according to the exemplary embodiment;

FIG. 11 shows the calculated spectral overlap for both axes after broadening with the conventional concave-concave Herriott cell; and

FIG. 12 shows a schematic diagram of a laser system 200 according to an exemplary embodiment.

### DESCRIPTION OF EXEMPLARY EMBODIMENTS

In the drawings, the same or similar elements in the various exemplary embodiments are designated with the same reference signs for the sake of simplicity. The terms laser beam and laser pulse are used as synonyms, since pulsed laser radiation is also to be described in terms of the optical path in the form of a laser beam.

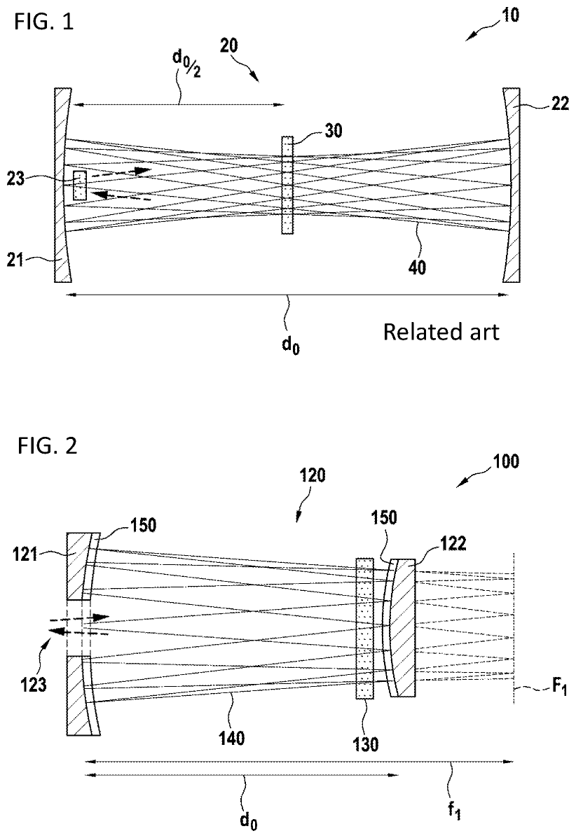

FIG. 1 shows a schematic diagram of a conventional device 10 for spectral broadening of a laser pulse with a conventional concave-concave multipass arrangement 20 according to the related art, which is designed as a Herriott cell (HC). This conventional multipass arrangement 20 has two concave mirrors 21 and 22, which are arranged relative to each other in such a way that an in-coupled laser beam is reflected between the two concave mirrors 21 and 22. Due to the concave shape of the reflecting surfaces of the mirrors 21 and 22, the laser beam is focused, whereby the focal plane is arranged centrally between the two mirrors 21 and 22. Accordingly, the laser beam 40 has the largest beam diameter at the reflection surfaces of the mirrors 21 and 22 and the smallest beam diameter in the focal plane.

Furthermore, the device 10 has a nonlinear optical medium 30, which is in solid state form. The nonlinear medium 30 is arranged in the focal plane, since this is where the smallest beam diameter and thus the greatest intensity of the laser pulses prevail, which is decisive for the nonlinear optical effects and in particular for the spectral broadening.

In addition, the device 10 has an in-coupling and out-coupling mirror 23 by means of which a laser beam 40 can be coupled into and out of the multipass arrangement 20.

The optical path of the laser beam 40 is drawn by means of an exemplary line and shows that the laser beam 40, after coupling into the multipass arrangement 20, travels around the multipass arrangement 20 several times before the laser beam 40 is coupled out again by the in-coupling and out-coupling mirror 23. In this process, the laser pulse passes through the nonlinear medium 30 in the focal plane, in which the desired nonlinear optical processes for spectral broadening take place, after each reflection at the mirrors 21 and 22, i.e., twice per complete circulation.

While high intensities are required in the nonlinear optical medium 30 in the focal plane, the intensity of the laser pulses must be significantly lower at the reflection surfaces of the mirrors 21 and 22 to ensure that the destruction threshold of mirrors 21 and 22 is not exceeded. For this purpose, the laser beam must have a sufficiently large beam diameter at the reflection surfaces of the mirrors 21 and 22, which is achieved by a sufficiently large distance of the mirrors from the focal plane and a correspondingly large focal length of the mirrors 21 and 22. This is accompanied by the fact that the diameters of the concave mirrors 21 and 22 must also be selected to be correspondingly large. In the illustration shown, the mirror distance d₀ corresponds to the sum of the focal lengths of the mirrors 21 and 22, which in the example shown is d₀/2 in each case.

Since a large focus is typically desired in the focal plane to spectrally broaden high-intensity laser pulses, concave mirrors with a long focal length are required. Smaller focal lengths would result in a smaller mode size in the focus, increasing undesirable effects in the nonlinear optical medium 30. The consequence of the large focal lengths to be selected accordingly is that the distance d₀ must be chosen to be correspondingly large in order to ensure a sufficient beam diameter on the reflection surfaces of the mirrors 21 and 22. This brings with it the disadvantage that the multipass arrangements 20 according to the related art usually have very large spatial dimensions, in particular a large length, which is not infrequently several meters. This can be a major challenge for the use in laser systems, especially for industry, with regard to the space requirements of the laser system.

FIG. 2 shows a schematic representation of a device 100 for spectral broadening of a laser pulse according to an exemplary embodiment of the disclosure. The device 100 has a multipass arrangement 120 comprising a concave mirror 121 and a convex mirror 122. The concave and convex mirrors 121, 122 are thereby arranged relative to each other such that a laser beam 140 coupled into the multipass arrangement 120 is reflected several times between the two mirrors 121, 122 before the laser beam is coupled out of the multipass arrangement 120 again. For coupling the laser beam 140 into and out of the multipass arrangement 120, the concave mirror 121 has an in-coupling and out-coupling aperture 123 through which the laser beam 140 can pass during in-coupling and out-coupling to enter or leave the multipass arrangement 120 accordingly.

In addition, the device 100 includes a nonlinear optical medium 130 arranged in the multipass arrangement 120. The nonlinear optical element is arranged apart from the center of the multipass arrangement 120 and is located close to the convex mirror 122, since the laser beam 140 has a smaller diameter there than at other positions in the multipass arrangement 120, which are closer to the concave mirror 121. The nonlinear optical medium 130 is thereby arranged and formed in such a way that the laser beam 140 passes through the nonlinear optical medium 130 after each reflection, i.e., twice per circulation in the multipass arrangement 120. For this purpose, it may be advantageous if the nonlinear medium 130 has approximately a similar lateral extent as the convex mirror 122 to ensure that the laser beam passes through the nonlinear optical medium 130 in all circulations. According to the exemplary embodiment shown, the nonlinear medium 130 is in solid state form. According to other exemplary embodiments, the device 100 may additionally or alternatively comprise a gaseous nonlinear medium. For this purpose, for example, the multipass arrangement 120 or the device 100 may be formed as a pressure chamber which can be filled with a suitable gas at the desired pressure.

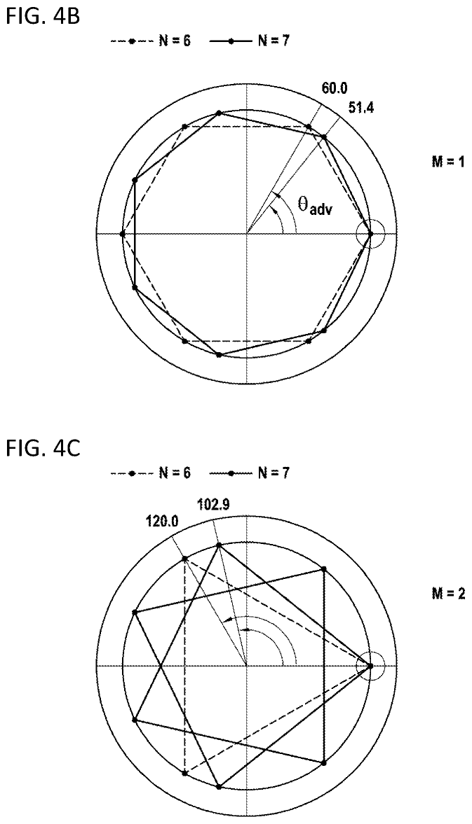

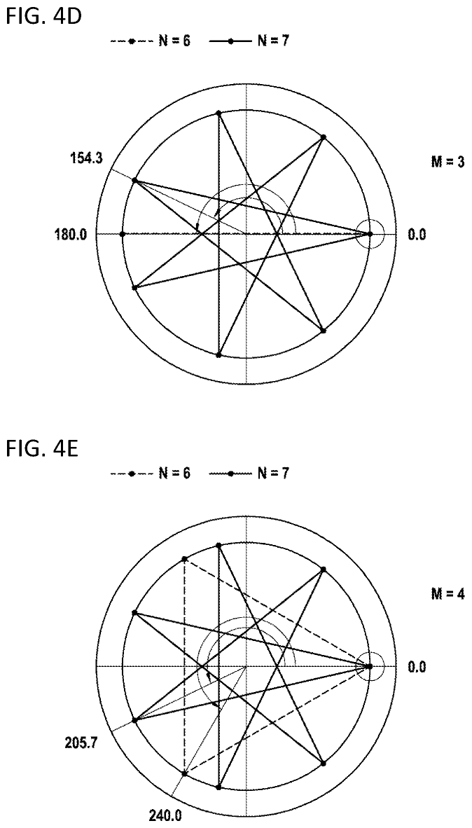

As can be seen in FIG. 1, the distance d₀ of the two mirrors 121 and 122 differs from the focal length f1 of at least the concave mirror 121 and optionally also from the focal length f2 (see FIG. 4A) of the convex mirror 122. Here, the focal length f1 of the concave mirror 121 is longer than the distance of the concave mirror 121 from the convex mirror, so that the focal plane F1 of the concave mirror 121 lies outside the multipass arrangement 120. Since the convex mirror 122 is a diverging mirror, its focal plane or focus (not shown) lies outside the multipass arrangement 120. As a result, the laser beam is not focused within the multipass arrangement 120 and, consequently, undesirable effects such as exceeding the destruction threshold of the mirrors 121 and 122, ionization of air or other gases in the multipass arrangement 120, and critical self-focusing can be easily avoided. Nevertheless, in order to achieve a sufficiently high B-integral and an associated desired spectral broadening of the laser pulse, the nonlinear optical medium 130 can be adapted with respect to its nonlinear refractive index and/or its thickness and/or the number of circulations of the laser beam 140 in the multipass arrangement 120 can be increased compared to conventional concave-concave multipass arrangements 20.

To achieve control of the dispersion of the laser pulse already in the multipass arrangement 120, the mirrors 121 and 122 can each be provided with an optional dispersive dielectric coating 150 on their reflection surface. This can be designed in such a way that the dispersion which the laser pulse collects during propagation through the nonlinear optical medium 130 is at least partially compensated. Optionally, the dispersion can also be overcompensated, for example to achieve self-compression of the laser pulse. For example, the dispersive coating(s) 150 may be configured to at least partially compensate for the GDD and TOD that the laser pulse collects in the nonlinear optical medium 130. In other exemplary embodiments, only one of the mirrors 121 and 122 may have such a dispersive coating 150. According to further exemplary embodiments, neither of the mirrors 121 and 122 may comprise a dispersive coating. Optionally, the device 100 or a laser system using the device 100 may include dispersive optical elements (not shown), such as dispersive dielectric mirrors, to control and/or compensate for dispersion elsewhere.

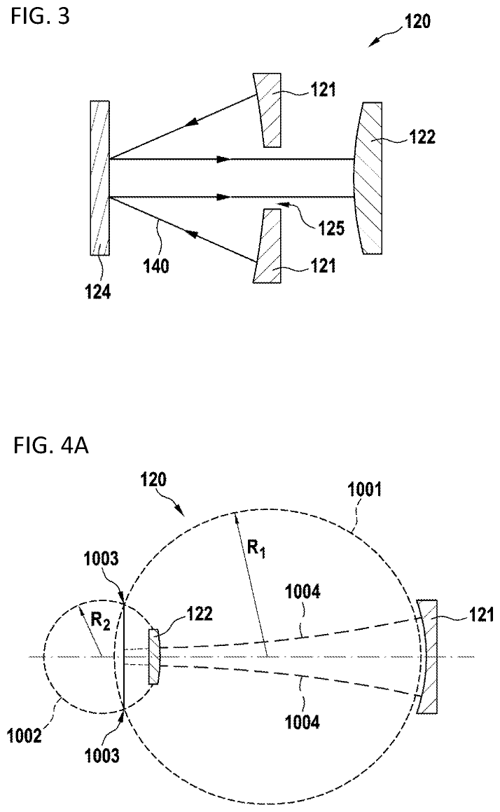

FIG. 3 shows a schematic representation of a multipass arrangement 120 according to a further exemplary embodiment. This multipass arrangement 120 differs from the multipass arrangement 120 shown in FIG. 2 in that it has a deflection mirror 124 in addition to the concave mirror 121 and the convex mirror 122. The multipass arrangement 120 is constructed in such a way that the laser beam 140 is reflected from the concave mirror 121 to the deflection mirror 124 and via the deflection mirror 124 to the convex mirror 122. On the return path of the circulation of the laser beam 140 from the convex mirror 122 to the concave mirror, a deflection also takes place by the deflection mirror 124. According to the exemplary embodiment shown, the concave mirror has a significantly larger diameter than the convex mirror and also has a recess 125 through which the laser beam 140 can pass through the concave mirror 121. In this case, the convex mirror 122 is arranged behind the concave mirror 121 so that the laser beam 140 passing through the recess 125 can strike the convex mirror and be reflected back by the convex mirror through the recess 125. According to other exemplary embodiments (not shown), the convex mirror may also be arranged in front of the concave mirror.

The multipass arrangement 120 according to this exemplary embodiment is similar in design to a Cassegrain telescope. The structure of the multipass arrangement 120 shown offers the advantage that the spatial extent of the multipass arrangement 120, in particular its length, can be reduced by deflecting the laser beam 140, and the multipass arrangement 120 can therefore be designed to save space. This can be advantageous, in particular, for use in laser systems that have a severely limited amount of space. Furthermore, this offers the advantage that despite the reduced spatial dimensions, the path length of the optical path of the laser beam in the multipass arrangement 120 can be maintained or even increased. Furthermore, the exemplary embodiment offers the advantage, in particular compared to the concave-concave Herriott cells known from the prior art, that the beam diameter of the laser beam 140 at the deflection mirror has a sufficient size and, in particular, is larger than on the convex mirror 122 and, therefore, there is no need to fear exceeding the destruction threshold of the deflection mirror.

FIG. 4A shows a schematic explanation for the stability criteria of a concave-convex multipass arrangement 120 as known from geometrical optics. The multipass arrangement 120 shown in FIG. 4A has a concave mirror 121 whose reflecting surface has a radius of curvature R₁, which is shown by means of an arrow and a corresponding circumference 1001. Furthermore, the multipass arrangement 120 has a convex mirror 121 whose reflection surface has a radius of curvature R₂. Since the reflection surface of the convex mirror 122 is curved outward, the center of the circumference 1002 with radius of curvature R2 is located behind the convex mirror 122. The concave-convex multipass arrangement 120 is then considered stable, in the sense of a stable resonator which allows a plurality of circulations of a laser beam between the mirrors before the laser beam is decoupled from the resonator or from the multipass arrangement 120, when the concave mirror 121 and the convex mirror 122 are spaced apart from each other such that the circumferential circles 1001 and 1002 spanned by their radii of curvature R₁ and R₂ intersect and form an overlap. This is the case in the configuration shown, as the two circumferential circles 1001 and 1002 intersect at points 1003. In full three-dimensional view, these are not merely points of intersection, but rather a corresponding circle of intersection, which, however, can be seen in the two-dimensional projection shown as merely two points of intersection. The dashed line 1004 marks the mode volume of the resonator or of the multipass arrangement 120, in which the resonant beam trajectories in the multipass arrangement 120 propagate. Beams outside the mode volume leave the multipass arrangement 120 and therefore do not propagate resonantly in the multipass arrangement 120.

In the following, specific examples of devices for spectral broadening of a laser pulse according to exemplary embodiments of the disclosure and in particular concave-convex multipass arrangements are explained, without, however, limiting the disclosure to these examples. The exemplary embodiments are also partially characterized and compared to a conventional related art concave-convex Herriott cell.

### Example 1

In the following, a specific example of a device 100 for spectral broadening of a laser pulse with a multipass arrangement 120 according to an exemplary embodiment is explained in detail and compared with a conventional related art Herriott cell.

For comparison with the prior art, we use a conventional Herriott cell, which is known and described in the prior related (M. Kaumanns et al., “Multipass spectral broadening of 18 mJ pulses compressible from 1.3 ps to 41 fs,” Optics letters, vol. 43, no. 23, pp. 5877-5880, 2018, doi: 10.1364/OL.43.005877). This comprises a multipass arrangement with two spherical concave mirrors, each with a radius of curvature of −1,5 m and spaced d₀=2,98 m apart. This multipass arrangement is designed in such a way that an in-coupled laser pulse passes through N=23 full circulations in the multipass arrangement before the laser beam is coupled out from the multipass arrangement again and completes 45 revolutions through the nonlinear optical medium. According to the example shown, the parameter M has the value M=22.

The multipass arrangement is constructed in the manner of a Herriott cell, i.e., the reflection points at which the laser beam is reflected on the cell mirrors lie on a circle or an ellipse. For a given number N of reflections on the cell mirror, several different cell configurations are possible, which differ in the order of the reflections. The parameter M−1 indicates how many neighboring reflection points lie between two temporally successive reflection points, i.e., how many reflection points are “jumped over.” An alternative consideration is how many full circles/ellipses are described by the reflection point pattern on the cell mirrors. The ratio of M and N indicates the stability and thus do as well as the mode size in the Herriott cell.

FIGS. 4B to 4E show exemplary reflection patterns for different values of the parameters N and M on a mirror surface and designate some angles of the reflection points. The curves of the reflection points are shown for N=6 and N=7. The reflection patterns in FIGS. 4B to 4E differ in the values of the parameter M, which is M=1 (FIG. 4B), M=2 (FIG. 4C), M=3 (FIG. 4D) and M=4 (FIG. 4E), respectively. It can be seen that, despite the same number of circulations (parameter N), the arrangement of the reflection points on the mirrors can differ significantly for different parameters M. The dashed line represents the circulation pattern for N=6, while the solid line represents the circulation pattern for N=7. The angles refer to a 0° position at the rightmost point at the 3 o'clock position.

This conventional device has as a limiting factor the destruction threshold of the optical coating of the concave mirrors, which was determined to be 0.25 J/cm². To ensure reliable operation of this conventional device, the fluence to laser radiation was set to 66% of the damage threshold, i.e., 0.17 J/cm². The eigenmode of the conventional Herriott cell has a diameter of 5.4 mm, which enables a maximum pulse energy of

$${E}_{max} = \frac{0.17 J}{{cm}^{2}} \cdot {( 0.27 cm )}^{2} \cdot π / 2 = 18.6 mJ .$$

Another limiting factor is gas ionization, which occurs with argon as the nonlinear optical medium used at a gas pressure of 600 mbar at a pulse energy of about 18.3 mJ. At a pulse duration of 1.3 ps, this corresponds to an intensity at the focus of approx

$$2 \cdot 1 {0}^{13} \frac{W}{{cm}^{2}} .$$

The proportionality factor of the ionization threshold to the gas pressure was determined by measurements to be approx.

$$∼ {p}^{- \frac{1}{2.5}}$$

where p is the gas pressure of argon.

According to a first exemplary embodiment of the disclosure, which is compared with the prior art, the multipass arrangement of the device has a spherical concave mirror with a radius of curvature of R₁=−11.0 m and a spherical convex mirror with a radius of curvature of R₂=8.5 m, which are arranged at a distance of d₀=3.07 m from each other. The multipass arrangement is designed in such a way that a coupled laser beam propagates N=23 full revolutions in the multipass arrangement before the laser beam is coupled out again.

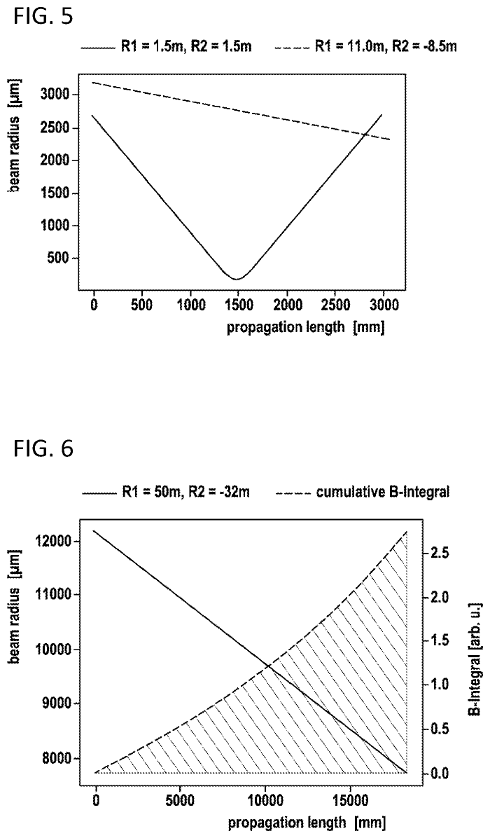

FIG. 5 shows in a diagram the course of the beam radius in μm (vertical axis) along the propagation length through the conventional Herriott cell or multipass arrangement in mm (horizontal axis). The solid line represents the course for the conventional concave-concave Herriott cell, while the dashed line represents the course of the beam radius for the concave-convex multipass arrangement according to the exemplary embodiment. It can be seen that only the conventional HC has a highly focused eigenmode, which leads to a beam radius of less than 500 μm at about 1,500 mm propagation length. This can lead to undesirable ionization of the existing gas atmosphere. In the concave-convex multipass arrangement according to the exemplary embodiment, on the other hand, there is no strong focusing within the multipass arrangement, so that the course of the beam radius shown with the dashed line is always greater than 2,000 μm and therefore no undesirable ionization is to be feared.

Although the concave-convex multipass arrangement has approximately the same length as the conventional concave-concave HC (the difference in length is only 3%) and has a beam diameter on the convex mirror that is approximately 15% smaller than on the concave mirror, resulting in an approximately 33% increase in fluence, ionization of gas is nevertheless completely prevented in the multipass arrangement because there is no focus of the laser beam in the multipass arrangement. The lower intensity of the laser beam in the concave-convex multipass arrangement compared to the focus in the conventional concave-concave HC offers the advantage that the concave-convex device can be used for spectral broadening and compression of laser pulses with significantly larger pulse energies, especially for laser pulses of such intensities which cannot be broadened and compressed in a conventional concave-concave HC due to the limitations described above. In order to achieve an appropriate B-integral with a concave-convex multipass arrangement, which depends on the intensity of the laser pulse as explained above, for laser pulses with more moderate energies the nonlinear medium can be adapted to exhibit a correspondingly higher nonlinear refractive index. For this purpose, for example, when using a gaseous nonlinear optical medium, such as argon, the gas pressure can be increased and additionally or alternatively a solid nonlinear optical medium with a significantly higher nonlinear refractive index can be used.

### Example 2

In the following, a device according to another exemplary embodiment of the disclosure is described, which is designed for spectral broadening and compression of laser pulses with a pulse energy of 0.5 J and a pulse duration of 1.3 ps (FWHM).

Conventional concave-concave HCs are per se unsuitable for such an application, since this would require length scaling, which would make such an HC inaccessible for practical use due to its considerable spatial length.

The device according to the further exemplary embodiment has a concave-convex multipass arrangement with a spherical concave mirror with a radius of curvature R₁=−50.0 m, a convex mirror with a radius of curvature of R₂=32 m and a mirror spacing of d₀=18.35 m. The multipass arrangement is designed in such a way that a coupled laser beam remains in the multipass arrangement for N=49 circulations and M=1. Since a concave-convex multipass arrangement is used, the multipass arrangement or the optical path in the multipass arrangement can be folded by means of a deflection mirror, as shown for example in FIG. 3. The length of the multipass arrangement can thus be reduced to well below 8 m. The pulse energy of the laser pulses to be broadened is sufficiently high to use argon gas at a pressure of 1 bar as the nonlinear optical medium for the broadening, so that a cumulative B integral per passage through the nonlinear optical medium of about 2.8 can be achieved.

FIG. 6 shows in a graph with the solid line the beam radius in μm (left vertical axis) and with the dashed line the cumulative B integral in arbitrary units (right vertical line) versus the propagation length through the multipass arrangement. Since the multipass arrangement is completely filled with argon, the propagation length of the laser pulse through the multipass arrangement is equal to the propagation length through the nonlinear optical medium.

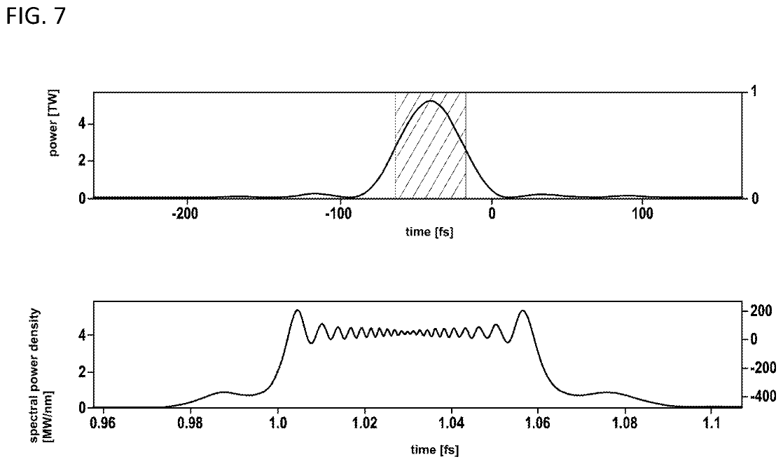

The calculated output pulses after spectral broadening and compression in the device according to the second exemplary embodiment is shown in FIG. 7. With the device according to this exemplary embodiment, the spectrum of the pulse according to the calculations is broadenable to a bandwidth of about 60 nm (FWHM), which is compressible to a pulse duration of less than 50 fs by means of a compensation of the GDD in the amount of −35,000 fs². Non-dispersive optics in the multipass arrangement were assumed. The performance of the device can be further improved by compensating the GDD of 300 fs² of argon per cycle. The peak intensity and peak fluence in the device thereby occur at the convex mirror with about 4-10¹¹ W/cm² and 0.5 J/cm², respectively. Both values are well below the destruction threshold of the optical elements and the ionization threshold of argon.

FIG. 7 shows in the upper graph the temporal power curve of the simulated laser pulse after spectral broadening and compression and in the lower graph the simulated spectrum after spectral broadening and compression.

### Example 3

In the following, an example of a device for spectral broadening of a laser pulse is explained according to another exemplary embodiment and compared with another conventional concave-concave system.

The device according to the exemplary embodiment has a concave-convex multipass arrangement with N=19, M=1, R₁=−0.5 m, R₂=0.25 m, and d₀=0.26 m.

For comparison, a conventional Herriott cell with N=19, M=18, R₁=−0.3 m, R₂=−0.3 m, d₀˜_{0˜}0.596 m was used. When used for spectral broadening of laser pulses of the commercially available laser system of the type PHAROS from the manufacturer LIGHT CONVERSION with an output pulse energy of 200 μJ and a pulse duration of 270 fs, a fused silica plate with a thickness of 6.35 mm can typically be placed as a nonlinear optical medium about 50 mm away from one of the mirrors to cause a B integral of about 0.6 when propagating through the fused silica plate. In this case, the laser pulse has a high enough peak power to cause significant nonlinear effects in the ambient air. The B integral due to propagation of the laser pulse through the air is therefore about 0.7.

In the proposed device according to this exemplary embodiment, the 6.35 mm thick fused silica plate can be placed at a distance of 56 mm from the concave mirror, resulting in a B-integral of 0.6. In contrast, the B-integral due to free propagation through air is much smaller than that of the conventional Herriott cell due to the shorter optical paths and larger beam diameters, and is as low as 0.04.

Therefore, by means of a device according to the disclosure based on a concave-convex multipass arrangement, self-phase modulation in air can be dramatically reduced and almost completely avoided.

### Example 4

In another experimental comparison, the spectral broadening of laser pulses was presented with another device based on a concave-convex multipass arrangement according to another exemplary embodiment and a conventional concave-concave Herriott cell.

Pulses of a commercially available laser system of the type PHAROS from the manufacturer LIGHT CONVERSION were spectrally broadened and compressed. The output pulses of the mentioned laser system before spectral broadening and compression have an average pulse energy of 15 μJ and a pulse duration (FWHM) of 266 fs with a resulting peak pulse power of 56.4 MW.

The device according to the exemplary embodiment of the disclosure has a multipass arrangement 120 in the form of a Herriott cell with a concave mirror 121 and a convex mirror 122, as shown in FIG. 2. The concave mirror has a radius of curvature R₁=−250 mm and the convex mirror has a radius of curvature of R₂=200 mm. The mirrors were coated in such a way that almost the entire GDD of the multipass arrangement is compensated. Here, the convex mirror has a dispersive coating with an effect of −140 fs² and the concave mirror has only a highly reflective coating. The distance between the mirrors of the multipass arrangement has d₀=114 mm and allows 19 reflections per mirror and correspondingly 38 propagations through the nonlinear medium, which is formed by a 3 mm thick fused silica plate with a diameter of 25.4 mm and anti-reflective coating on both sides. Coupling into and out of the multipass arrangement is accomplished by means of a Scarper mirror. Mode matching is performed by a Galilean beam expander. The eigenmode of the multipass arrangement is characterized by a Gaussian beam with a diameter of w₁=336 μm on the concave mirror or w₂=182 μm on the convex mirror. The nonlinear optical medium is located at a distance of d=110 mm from the concave mirror, where the beam has a diameter of w=193 μm.

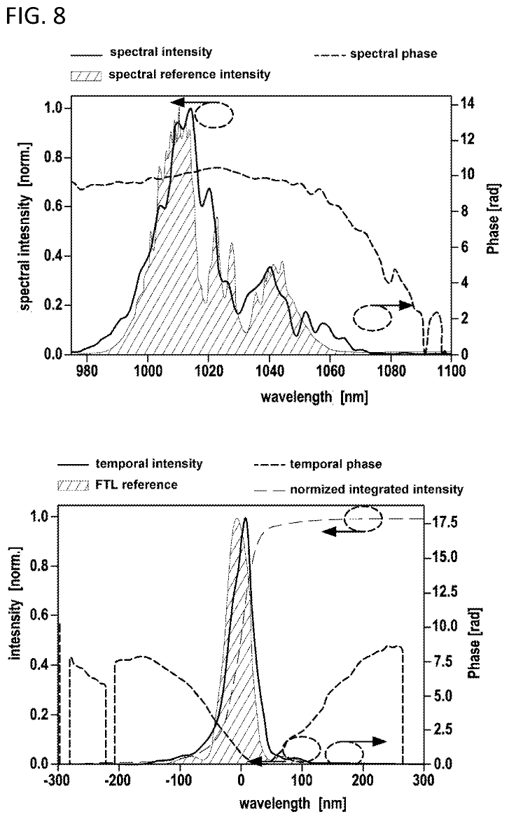

FIG. 8 shows the measured spectrum (gray) and the output spectrum (black line) determined by means of a FROG measurement after spectral broadening with the concave-convex device according to the exemplary embodiment, where a pulse energy of 15 μJ was used for the FROG measurement. The error of the FROG measurement is 7×10⁻³ on a 256×256 grid. In the bottom graph, FIG. 8 shows the temporal profile obtained from the FROG measurement (black line), the temporal phase profile (dashed) and, for reference, the Fourier limit (FTL) (gray), and the integrated intensity in the main pulse (dotted).

Accordingly, the output spectrum has a bandwidth of more than 50 nm at 1/e² of the spectral beam power. The Fourier limit of the spectrum is about 49 fs. Pulse compression is performed using six dispersive mirrors, each with −400 fs² GDD. Transmission through the device and compression level was determined to be 91%. A pulse shortening by a factor of 5 was determined, resulting in a pulse duration of 53 fs (FWHM), as shown in FIG. 8. The FROG measurements showed that 80% of the energy was contained in the main pulse.

A nonlinear phase of about 0.5 rad was also obtained with this device, resulting in a high quality beam profile after passing through the device. To confirm this, the spectral homogeneity of the compressed beam was measured using scans along two axes of the beam. The sagittal and tangential spectra were measured in 0.2 mm increments. For each recorded spectrum I_{λ}(λ) the overlapping portion with the central intensity spectrum was I_{λ}(λ) was calculated according to the following formula:

$$V = \frac{{[ \int \sqrt{{I}_{λ} ( λ ) * {I}_{λ}^{ref} ( λ )} d λ ]}^{2}}{\int {I}_{λ} ( λ ) d λ * \int {I}_{λ}^{ref} ( λ ) d λ}$$

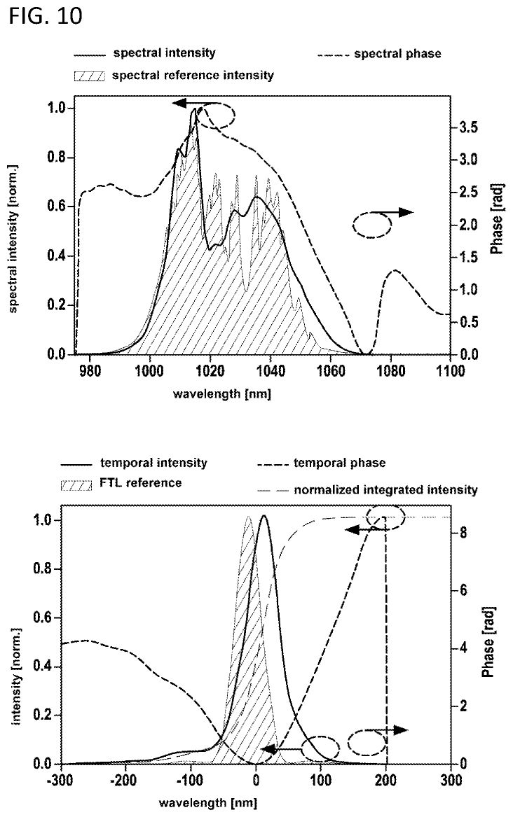

The calculated spectral overlap is shown for both axes in FIG. 10. To quantify the overall spectral homogeneity, a weighted overlap with intensity was calculated with the formula V_{avg}=ΣI*V/ΣI resulting in the values of Vₓ=98.9% and V_{y}=98.2%.

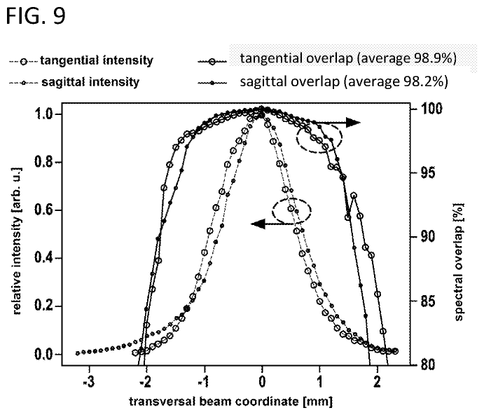

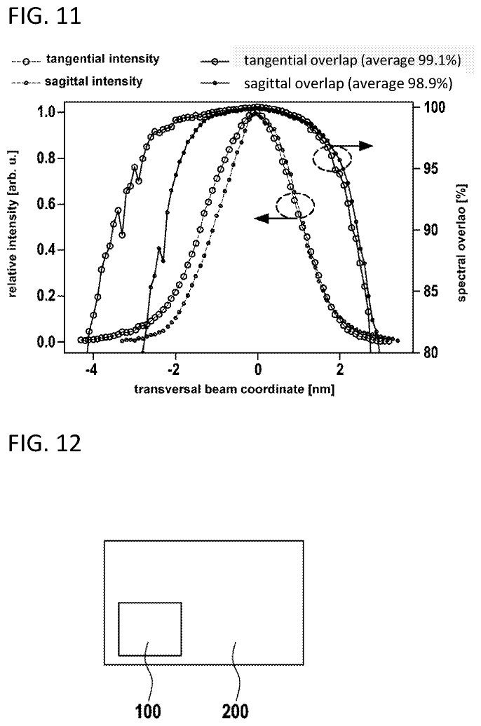

For comparison, the results of the equivalent measurements shown for the concave-convex device in FIGS. 8 and 10 are also shown for a conventional Herriott cell in FIGS. 9 and 11.

Here, the measured conventional concave-concave HC has a first concave mirror with a radius of curvature of −250 mm and a highly reflective coating. The second concave mirror has a radius of curvature of −200 mm and a dispersive coating with a GDD value of −140 fs². The two concave mirrors are spaced 378 mm apart, allowing 19 reflections per mirror and 38 revolutions through the nonlinear optical medium, which is a fused silica plate with an antireflection coating on both sides and a thickness of 3 mm. The nonlinear optical medium is located at a distance of 110 mm from the second concave mirror. The eigenmode of the HC is characterized by a Gaussian beam with a diameter of w₁=358 μm and w₂=471 μm on the concave mirrors, respectively, and w=195 μm in the nonlinear medium.

FIG. 9 shows the measured spectrum (gray) and the output spectrum (black line) determined by means of a FROG measurement after spectral broadening with the conventional concave-concave device according to the exemplary embodiment, where a pulse energy of 15 μJ was used for the FROG measurement. The error of the FROG measurement is 6×10⁻³ on a 256×256 grid. In the right graph, FIG. 9 shows the temporal profile obtained from the FROG measurement (black line), the temporal phase profile (dashed) and, for reference, the Fourier limit (FTL) (gray), and the integrated intensity in the main pulse (dotted). A spectral broadening of more than 50 nm at the 1/e² value of the spectral power was obtained. The corresponding Fourier transformed time limit (FTL) of this spectrum is about 53 fs (FWHM). The pulse was compressed to a pulse duration of 57 fs (FWHM) using a compressor arrangement with an overall compensation of −2,400 fs². The transmittance of the HC was determined to be 90%. A pulse shortening by a factor of 5 was achieved and confirmed with the FROG measurements shown in FIG. 9.

The calculated spectral overlap is shown for both axes in FIG. 11 and shows that for the conventional concave-concave HC the values are Vₓ=99.1% and V_{y}=98.9% were determined.

Thus, it can be stated that the spectral broadening, as well as the compressibility and the spectral homogeneity of the spectrum broadened with a concave-convex device are in no way inferior to a conventional concave-concave HC. Contrary to the prevailing assumption in the related art that concave-convex multipass arrangements are disadvantageous in these respects, the inventors are thus able to disprove it.

FIG. 12 shows in a schematic representation a laser system 200 according to an exemplary embodiment, which comprises a device 100 according to an exemplary embodiment of the disclosure for spectral broadening of a laser pulse. The device 100 may be integrated into the laser system 200 or formed separately therefrom. The laser pulses provided by the laser system 200 can thereby be supplied to the device 100 before further use, in which they pass through the concave-convex multipass arrangement and are spectrally broadened therein. Further, in the device 100 or elsewhere in the laser system, the laser pulse broadened by the device 100 may be compressed using one or more dispersive optics.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

### LIST OF REFERENCE SIGNS

10 Related art spectral broadening device
20 Multipass arrangement according to the related art
21 concave mirror
22 concave mirror
23 Coupling and decoupling mirrors
30 nonlinear optical medium
40 Laser beam
100 Device for spectral broadening
120 Multipass arrangement
121 concave mirror
122 convex mirror
123 In-coupling and out-coupling opening
124 Deflecting mirror
125 Recess
130 nonlinear optical medium
140 Laser beam
150 dispersive coating
1001 Circumference with radius of curvature R1
1002 Circumference with radius of curvature R2
1003 Intersection points of the radii of curvature
1004 Mode volume of the multipass arrangement
d₀ Mirror spacing of the multipass arrangement
f₁ Focal length of the concave mirror
F₁ Focal plane of the concave mirror
f₂ Focal length of the convex mirror
R₁ Radius of curvature of the first mirror
R₂ Radius of curvature of the second mirror

1. A device for spectrally broadening a laser pulse, the device comprising:
a multipass arrangement having a convex mirror and a concave mirror, the convex mirror and the concave mirror being arranged relative to each other such that a laser pulse coupled into the multipass arrangement is reflected at least once from the concave mirror to the convex mirror and at least once from the convex mirror to the concave mirror; and
a nonlinear optical medium arranged at least partially within the multipass arrangement such that the nonlinear optical medium is passed through multiple times by the laser pulse coupled into the multipass arrangement.

2. The device according to claim 1, wherein the nonlinear optical medium is passive.

3. The device according to claim 1, wherein the device is passive.

4. The device according to claim 1, wherein the multipass arrangement is configured such that the laser pulse coupled into the multipass arrangement is reflected multiple times, optionally more than ten times, from the concave mirror to the convex mirror and multiple times, optionally more than ten times, from the convex mirror to the concave mirror.

5. The device according to claim 1, wherein the multipass arrangement is configured such that the laser pulse coupled into the multipass arrangement is reflected from the concave mirror directly to the convex mirror and from the convex mirror directly to the concave mirror.

6. The device according to claim 1, wherein the multipass arrangement further comprises one or more deflection mirrors.

7. The device according to claim 1, wherein the nonlinear optical medium comprises a solid medium and/or a gaseous medium.

8. The device according to claim 7, wherein the solid-state nonlinear optical medium is formed at least partially of sapphire and/or SiC and/or fused silica and/or diamond.

9. The device according to claim 7, wherein the device is arranged in a pressure chamber and/or is formed as a pressure chamber and wherein the gaseous medium is provided in the pressure chamber.

10. The device according to claim 1, wherein the device and/or the multipass arrangement comprises at least one dispersive optical element configured to at least partially compensate or overcompensate for spectral dispersion caused in the nonlinear optical medium.

11. The device according to claim 10, wherein the dispersive optical element is formed as a dispersive coating of the concave mirror and/or the convex mirror, which is configured to at least partially compensate or overcompensate for spectral dispersion caused in the nonlinear optical medium.

12. The device according to claim 1, wherein the concave mirror and/or the convex mirror comprise a recess for coupling the laser pulse into the multipass arrangement and/or for coupling the laser pulse out of the multipass arrangement.

13. The device according to claim 1, wherein the multipass arrangement comprises or is configured as a Herriott cell.

14. A laser system comprising the device for spectrally broadening a laser pulse according to claim 1.

15. A method of spectrally broadening a laser pulse, the method comprising:
providing a multipass arrangement having a convex mirror and a concave mirror for spectral broadening of a laser pulse, in which the convex mirror and the concave mirror are arranged relative to one another such that a laser pulse coupled into the multipass arrangement is reflected at least once from the concave mirror to the convex mirror and at least once from the convex mirror to the concave mirror and the laser pulse propagates for spectral broadening through a nonlinear optical medium arranged in the multipass arrangement.
